(19) United States
(12) Patent Application Publication
(10) Pub. No.: US 2019/0238863 A1
(43) Pub. Date: Aug. 1, 2019

(54) CHROMA COMPONENT CODING UNIT DIVISION METHOD AND DEVICE

(71) Applicant: LG ELECTRONICS INC., Seoul (KR)

(72) Inventors: Sunmi YOO, Seoul (KR); Hyeongmoon JANG, Seoul (KR); Jin HEO, Seoul (KR)

(21) Appl. No.: 16/338,583

(22) PCT Filed: Aug. 14, 2017
(86) PCT No.: PCT/KR2017/008850

§ 371 Date: Apr. 1, 2019

Related U.S. Application Data
(60) Provisional application No. 62/403,726, filed on Oct. 4, 2016.

(51) Int. Cl. H04N 19/176; H04N 19/186; H04N 19/70

(52) U.S. Cl. CPC H04N 19/176; H04N 19/70; H04N 19/186

(57) ABSTRACT

The present invention provides a method for decoding a chroma block of a video signal, comprising the steps of: inducing division information of a luma block, wherein the division information of the luma block includes split depth information of the luma block; parsing depth inheritance information of the chroma block from a video signal, wherein the depth inheritance information indicates the degree of use of the split depth information of the luma block; inducing division information of the chroma block on the basis of the split depth information of the luma block and/or the depth inheritance information, wherein the division information of the chroma block includes split depth information of the chroma block; and decoding the chroma block on the basis of the division information of the chroma block.

### CROSS-REFERENCE TO RELATED APPLICATIONS

This application is the National Stage filing under 35 U.S.C. 371 of International Application No. PCT/KR2017/008850, filed on Aug. 14, 2017, which claims the benefit of U.S. Provisional Applications No. 62/403,726, filed on Oct. 4, 2016, the contents of which are all hereby incorporated by reference herein in their entirety.

### TECHNICAL FIELD

The present invention relates to a method and apparatus for encoding/decoding a video signal and, more particularly, to a method of defining an efficient coding unit partition when a chroma component is divided in a specific coding unit upon coding of a chroma component.

### BACKGROUND ART

Compression coding means a series of signal processing technologies for transmitting digitized information through a communication line or storing digitized information in a form suitable for a storage medium. Media, such as video, an image and voice, may become the subject of compression coding. Specifically, a technology for performing compression encoding on video is called video image compression.

In order to represent a digital image, various color space formats for a luma component and a chroma component are used. A color space format commonly used for video coding among the various color space formats is a YCbCr format. Y means a luma component, and Cb and Cr mean chroma components. A 4:2:0 format in which more information is assigned to a luma component is chiefly used because an eye of the human being is more sensitive to a luma component than to the chroma component. Each of the Cb component and the Cr component has a ¼ size of the luma component, and thus the chroma component may be represented by only the amount of data corresponding to half the luma component. It has been known that the human being does not significantly recognize small chroma information.

An efficient coding method of the chroma component has been researched in various ways because the 4:2:0 format is chiefly used for such digital image coding. In general, upon video-coding, first, after a luma component is coded, a corresponding chroma component is coded. In this case, information of the chroma component and information of the luma component have high similarity because they correspond to each other.

Accordingly, it is necessary to reduce a lot of additional information using information, coded in a luma component, for chroma component coding.

### DISCLOSURE

### Technical Problem

The present invention is to propose a method of encoding, decoding a video signal more efficiently.

Furthermore, the present invention is to propose a method of defining an efficient coding unit partition when a chroma component is divided in a specific coding unit when the chroma component is coded.

Furthermore, the present invention is to propose a method of referring to partition information used upon coding of a luma chroma and using the partition information.

Furthermore, the present invention is to propose a method of referring to partition information used upon coding of a luma chroma and using the partition information when a non-square partition is included upon the definition of a coding unit.

### Technical Solution

In order to accomplish the objects,

the present invention provides a method of defining an efficient coding unit partition (or coding block) when a chroma component is divided in a specific coding unit upon coding of the chroma component.

Furthermore, the present invention provides a method of referring division information (or partition information) used upon coding of a luma component and using the division information (or partition information) upon coding of a chroma component.

Furthermore, the present invention provides a method of referring division information (or partition information) used upon coding of a luma component when a coding unit includes a non-square block (or partition) and using the division information (or partition information) upon coding of a chroma component.

### Advantageous Effects

The present invention can reduce the number of bits for additional information of a chroma component because reference is made to division information (or partition information) of a luma component when a video signal is encoded or decoded.

### DESCRIPTION OF DRAWINGS

FIG. 1 is a block diagram illustrating a configuration of an encoder for encoding a video signal according to an embodiment of the present invention.

FIG. 2 is a block diagram illustrating a configuration of a decoder for decoding a video signal according to an embodiment of the present invention.

FIG. 3 is a diagram illustrating a division structure of a coding unit according to an embodiment of the present invention.

FIG. 4 is an embodiment to which the present invention is applied and is a diagram for illustrating a prediction unit.

FIG. 5 is an embodiment to which the present invention may be applied and is a diagram for illustrating a quadtree (hereinafter referred to as a “QT”) block division structure and problems thereof.

FIG. 6 is an embodiment to which the present invention is applied and is a diagram for illustrating a quadtree binarytree (hereinafter referred to as a “QTBT”) block division structure.

FIG. 7 is an embodiment to which the present invention is applied and is a diagram for illustrating a comparison between the block division structures of a QTBT for a luma component and a chroma component.

FIG. 8 is an embodiment to which the present invention is applied and shows that the division structure of a chroma component is determined using some of quadtree split information of a luma component.

FIG. 9 is an embodiment to which the present invention is applied and shows that the division structure of a chroma component is determined using some of quadtree and binarytree split information of a luma component.

FIG. 10 is an embodiment to which the present invention is applied and is a flowchart showing a process of dividing a chroma block based on division information of a luma block and depth inheritance information.

FIG. 11 is an embodiment to which the present invention is applied and is a flowchart showing a process of determining the division structure of a chroma block.

FIG. 12 is an embodiment to which the present invention is applied and is a flowchart showing a process of performing a QT split on a chroma block based on the QT split depth value and QT depth inheritance information of a luma block.

FIG. 13 is an embodiment to which the present invention is applied and is a flowchart showing a process of performing a QT/BT split on a chroma block based on the QT/BT split depth value and QT/BT depth inheritance information of a luma block.

### BEST MODE

The present invention provides a method of decoding a chroma block of a video signal, including deriving division information of a luma block, wherein the division information of the luma block includes split depth information of the luma block; parsing depth inheritance information for the chroma block from the video signal, wherein the depth inheritance information indicates a utilization degree of the split depth information of the luma block; deriving division information of the chroma block based on at least one of the split depth information of the luma block or the depth inheritance information, wherein the division information of the chroma block includes split depth information of the chroma block; and decoding the chroma block based on the division information of the chroma block.

In the present invention, the depth inheritance information indicates a predetermined value used to determine the split depth of the chroma block.

In the present invention, the split depth information of the chroma block is derived as a value obtained by subtracting the depth inheritance information from the split depth information of the luma block.

In the present invention, the split depth information of the chroma block, the split depth information of the luma block and the depth inheritance information correspond to any one of a quad-tree (QT), a binary-tree (BT) or a quad-tree binary-tree (QTBT).

The present invention further includes parsing an additional split flag from the video signal and dividing a split chroma block based on the additional split flag, wherein the split chroma block indicates a chroma block divided based on the split depth information of the chroma block, wherein the additional split flag indicates whether division is additionally performed on the divided chroma block.

In the present invention, the additional split flag includes at least one of a quad-tree (QT) split flag, a binary-tree (BT) split flag, or a quad-tree binary-tree (QTBT) split flag.

In the present invention, the depth inheritance information is defined in at least one level of a video parameter set, a sequence parameter set, a picture parameter set, a slice segment header, or a coding unit header.

The present invention provides an apparatus for decoding a chroma block of a video signal, including a parsing unit configured to parse depth inheritance information for the chroma block from the video signal, wherein the depth inheritance information indicates a utilization degree of split depth information of a luma block; a block split determination unit configured to derive the split depth information of the luma block and derive split depth information of the chroma block based on at least one of the split depth information of the luma block or the depth inheritance information; and a decoding unit configured to decode the chroma block based on division information of the chroma block.

The present invention further includes a parsing unit configured to parse an additional split flag from the video signal and a block split determination unit configured to divide a divided chroma block based on the additional split flag, wherein the divided chroma block indicates a chroma block divided based on the split depth information of the chroma block, wherein the additional split flag indicates whether division is additionally performed on the divided chroma block.

### MODE FOR INVENTION

Hereinafter, a configuration and operation of an embodiment of the present invention will be described in detail with reference to the accompanying drawings, a configuration and operation of the present invention described with reference to the drawings are described as an embodiment, and the scope, a core configuration, and operation of the present invention are not limited thereto.

Further, terms used in the present invention are selected from currently widely used general terms, but in a specific case, randomly selected terms by an applicant are used. In such a case, in a detailed description of a corresponding portion, because a meaning thereof is clearly described, the terms should not be simply construed with only a name of terms used in a description of the present invention and a meaning of the corresponding term should be comprehended and construed.

Further, when there is a general term selected for describing the invention or another term having a similar meaning, terms used in the present invention may be replaced for more appropriate interpretation. For example, in each coding process, a signal, data, a sample, a picture, a frame, and a block may be appropriately replaced and construed. Further, in each coding process, partitioning, decomposition, splitting, and division may be appropriately replaced and construed.

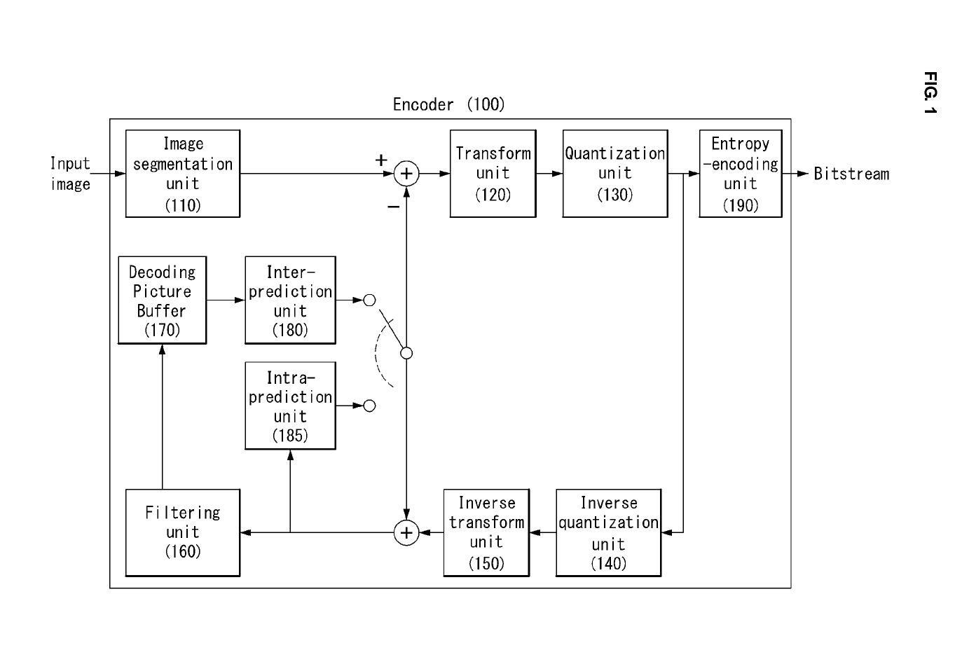

FIG. 1 shows a schematic block diagram of an encoder for encoding a video signal, in accordance with one embodiment of the present invention.

Referring to FIG. 1, an encoder 100 may include an image segmentation unit 110, a transform unit 120, a quantization unit 130, an inverse quantization unit 140, an inverse transform unit 150, a filtering unit 160, a DPB (Decoded Picture Buffer) 170, an inter-prediction unit 180, an intra-prediction unit 185 and an entropy-encoding unit 190.

The image segmentation unit 110 may divide an input image (or, a picture, a frame) input to the encoder 100 into one or more process units. For example, the process unit may be a coding tree unit (CTU), a coding unit (CU), a prediction unit (PU), or a transform unit (TU).

An embodiment of the present invention provides a method of defining an efficient coding unit partition when a chroma component is divided in a specific coding unit upon coding of the chroma component.

Furthermore, the present invention provides a method of referring to partition information used upon coding of a luma chroma and using the partition information.

Furthermore, the present invention provides a method of referring to partition information used upon coding of a luma chroma when a non-square partition is included upon defining of a coding unit and using the partition information.

Furthermore, the present invention provides a method of inheriting some of the quadtree structure of a chroma component or inheriting some of the quadtree and binarytree of a luma component.

However, the terms are used only for convenience of description of the present invention, and the present invention is not limited to the definition of a corresponding term. Furthermore, in this specification, a term called a coding unit is used as a unit used in a process of encoding or decoding a video signal, for convenience of description, but the present invention is not limited thereto and the unit may be properly interpreted depending on invention contents.

The encoder 100 may generate a residual signal by subtracting a prediction signal, output by the inter prediction unit 180 or the intra prediction unit 185, from an input video signal. The generated residual signal is transmitted to the transform unit 120.

The transform unit 120 may generate a transform coefficient by applying a transform scheme to the residual signal. The transform process may be applied to square pixel blocks having the same size and may be applied to non-square blocks of variable sizes.

The quantization unit 130 may quantize the transform coefficient and transmit it to the entropy encoding unit 190. The entropy encoding unit 190 may entropy-code the quantized signal and output it as a bit stream.

The quantized signal output by the quantization unit 130 may be used to generate a prediction signal. For example, dequantization and inverse transform may be applied to the quantized signal through the dequantization unit 140 and the inverse transform unit 150 within a loop, thereby being capable of reconstructing a residual signal. A reconstructed signal may be generated by adding the reconstructed residual signal to a prediction signal output by the inter prediction unit 180 or the intra prediction unit 185.

Meanwhile, in the compression process, adjacent blocks may be quantized by different quantization parameters, so that deterioration of the block boundary may occur. This phenomenon is called blocking artifacts. This is one of important factors for evaluating image quality. A filtering process may be performed to reduce such deterioration. Using the filtering process, the blocking deterioration may be eliminated, and, at the same time, an error of a current picture may be reduced, thereby improving the image quality.

The filtering unit 160 may apply filtering to the reconstructed signal and then outputs the filtered reconstructed signal to a reproducing device or the decoded picture buffer 170. The filtered signal transmitted to the decoded picture buffer 170 may be used as a reference picture in the inter-prediction unit 180. In this way, using the filtered picture as the reference picture in the inter-picture prediction mode, not only the picture quality but also the coding efficiency may be improved.

The decoded picture buffer 170 may store the filtered picture for use as the reference picture in the inter-prediction unit 180.

The inter-prediction unit 180 may perform temporal prediction and/or spatial prediction with reference to the reconstructed picture to remove temporal redundancy and/or spatial redundancy. In this case, the reference picture used for the prediction may be a transformed signal obtained via the quantization and inverse quantization on a block basis in the previous encoding/decoding. Thus, this may result in blocking artifacts or ringing artifacts.

Accordingly, in order to solve the performance degradation due to the discontinuity or quantization of the signal, the inter-prediction unit 180 may interpolate signals between pixels on a subpixel basis using a low-pass filter. In this case, the subpixel may mean a virtual pixel generated by applying an interpolation filter. An integer pixel means an actual pixel existing in the reconstructed picture.

The interpolation method may include linear interpolation, bi-linear interpolation and Wiener filter, etc. The interpolation filter may be applied to the reconstructed picture to improve the accuracy of the prediction. For example, the inter-prediction unit 180 may apply the interpolation filter to integer pixels to generate interpolated pixels. The inter-prediction unit 180 may perform prediction using an interpolated block composed of the interpolated pixels as a prediction block.

The intra-prediction unit 185 may predict a current block by referring to samples in the vicinity of a block to be encoded currently. The intra-prediction unit 185 may perform a following procedure to perform intra prediction. First, the intra-prediction unit 185 may prepare reference samples needed to generate a prediction signal. Then, the intra-prediction unit 185 may generate the prediction signal using the prepared reference samples. Thereafter, the intra-prediction unit 185 may encode a prediction mode. At this time, reference samples may be prepared through reference sample padding and/or reference sample filtering. Since the reference samples have undergone the prediction and reconstruction process, a quantization error may exist. Therefore, in order to reduce such errors, a reference sample filtering process may be performed for each prediction mode used for intra-prediction.

The prediction signal generated via the inter-prediction unit 180 or the intra-prediction unit 185 may be used to generate the reconstructed signal or used to generate the residual signal.

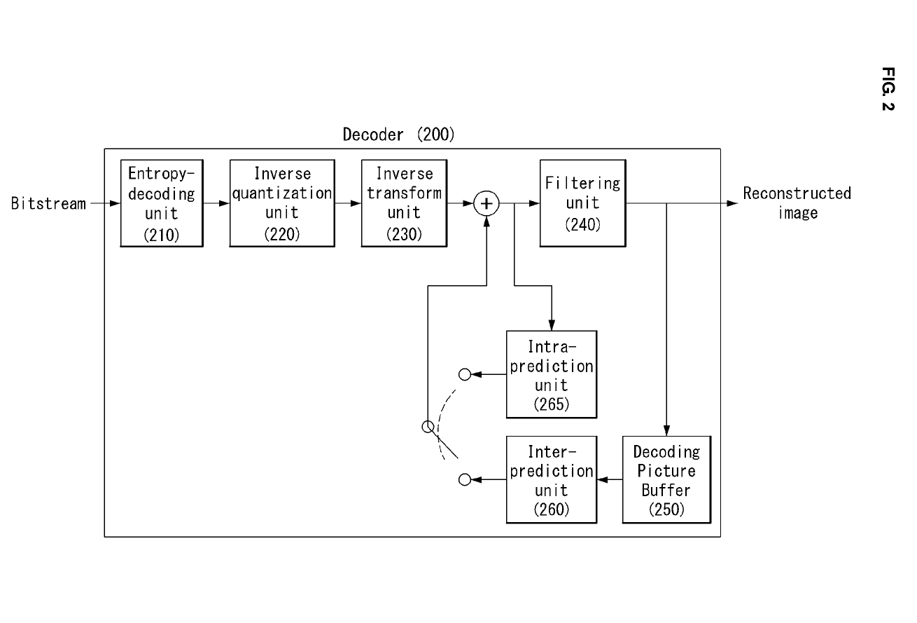

FIG. 2 is an embodiment to which the present invention is applied and is a schematic block diagram of a decoder in which the decoding of a video signal is performed.

Referring to FIG. 2, the decoder 200 may be configured to include a parsing unit (not shown), an entropy decoding unit 210, a dequantization unit 220, an inverse transform unit 230, a filtering unit 240, a decoded picture buffer (DPB) unit 250, an inter prediction unit 260, an intra prediction unit 265 and a reconstruction unit (not shown).

For another example, the decoder 200 may be simply represented as including a parsing unit (not shown), a block split determination unit (not shown) and a decoding unit (not shown). In this case, embodiments to which the present invention is applied may be performed through the parsing unit (not shown), the block split determination unit (not shown) and the decoding unit (not shown).

The decoder 200 may receive a signal output by the encoder 100 of FIG. 1, and may parse or obtain a syntax element through the parsing unit (not shown). The parsed or obtained signal may be entropy-decoded through the entropy decoding unit 210.

The dequantization unit 220 obtains a transform coefficient from the entropy-decoded signal using quantization step size information.

The inverse transform unit 230 obtains a residual signal by inversely transforming the transform coefficient.

The reconstruction unit (not shown) generates a reconstructed signal by adding the obtained residual signal to a prediction signal output by the inter prediction unit 260 or the intra prediction unit 265.

The filtering unit 240 applies filtering to the reconstructed signal and transmits the filtered signal to a playback device or transmits the filtered signal to the decoded picture buffer unit 250. The filtered signal transmitted to the decoded picture buffer unit 250 may be used as a reference picture in the inter prediction unit 260.

In this specification, the embodiments described in the filtering unit 160, inter prediction unit 180 and intra prediction unit 185 of the encoder 100 may be identically applied to the filtering unit 240, inter prediction unit 260 and intra prediction unit 265 of the decoder, respectively.

The reconstructed video signal output by the decoder 200 may be played back through a playback device.

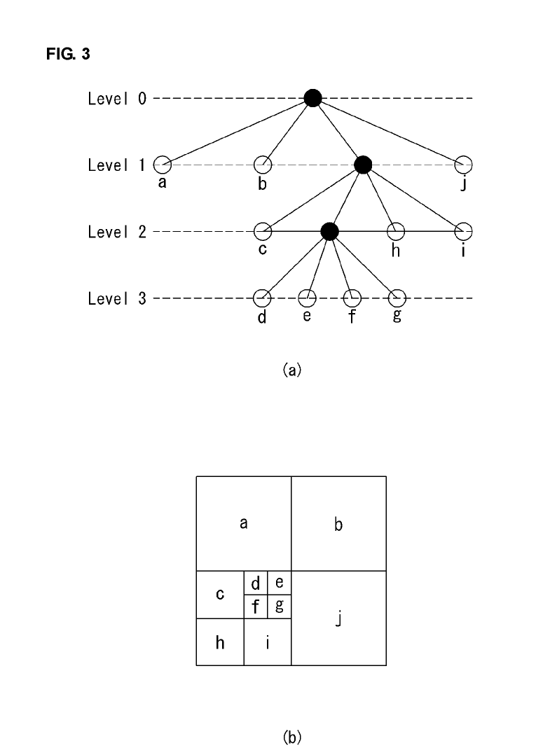

FIG. 3 is a diagram illustrating a division structure of a coding unit according to an embodiment of the present invention.

The encoder may split one video (or picture) in a coding tree unit (CTU) of a quadrangle form. The encoder sequentially encodes by one CTU in raster scan order.

For example, a size of the CTU may be determined to any one of 64×64, 32×32, and 16×16, but the present invention is not limited thereto. The encoder may select and use a size of the CTU according to a resolution of input image or a characteristic of input image. The CTU may include a coding tree block (CTB) of a luma component and a coding tree block (CTB) of two chroma components corresponding thereto.

One CTU may be decomposed in a quadtree (hereinafter, referred to as ‘QT’) structure. For example, one CTU may be split into four units in which a length of each side reduces in a half while having a square form. Decomposition of such a QT structure may be recursively performed.

Referring to FIG. 3, a root node of the QT may be related to the CTU. The QT may be split until arriving at a leaf node, and in this case, the leaf node may be referred to as a coding unit (CU).

The CU may mean a basic unit of a processing process of input image, for example, coding in which intra/inter prediction is performed. The CU may include a coding block (CB) of a luma component and a CB of two chroma components corresponding thereto. For example, a size of the CU may be determined to any one of 64×64, 32×32, 16×16, and 8×8, but the present invention is not limited thereto, and when video is high resolution video, a size of the CU may further increase or may be various sizes.

Referring to FIG. 3, the CTU corresponds to a root node and has a smallest depth (i.e., level 0) value. The CTU may not be split according to a characteristic of input image, and in this case, the CTU corresponds to a CU.

The CTU may be decomposed in a QT form and thus subordinate nodes having a depth of a level 1 may be generated. In a subordinate node having a depth of a level 1, a node (i.e., a leaf node) that is no longer split corresponds to the CU. For example, as shown in FIG. 3B, CU(a), CU(b), and CU(j) corresponding to nodes a, b, and j are split one time in the CTU and have a depth of a level 1.

At least one of nodes having a depth of a level 1 may be again split in a QT form. In a subordinate node having a depth of a level 2, a node (i.e., a leaf node) that is no longer split corresponds to a CU. For example, as shown in FIG. 3B, CU(c), CU(h), and CU(i) corresponding to nodes c, h, and l are split twice in the CTU and have a depth of a level 2.

Further, at least one of nodes having a depth of a level 2 may be again split in a QT form. In a subordinate node having a depth of a level 3, a node (i.e., a leaf node) that is no longer split corresponds to a CU. For example, as shown in FIG. 3B, CU(d), CU(e), CU(f), and CU(g) corresponding to d, e, f, and g are split three times in the CTU and have a depth of a level 3.

The encoder may determine a maximum size or a minimum size of the CU according to a characteristic (e.g., a resolution) of video or in consideration of encoding efficiency. Information thereof or information that can derive this may be included in a bit stream. A CU having a maximum size may be referred to as a largest coding unit (LCU), and a CU having a minimum size may be referred to as a smallest coding unit (SCU).

Further, the CU having a tree structure may be hierarchically split with predetermined maximum depth information (or maximum level information). Each split CU may have depth information. Because depth information represents the split number and/or a level of the CU, the depth information may include information about a size of the CU.

Because the LCU is split in a QT form, when using a size of the LCU and maximum depth information, a size of the SCU may be obtained. Alternatively, in contrast, when using a size of the SCU and maximum depth information of a tree, a size of the LCU may be obtained.

For one CU, information representing whether a corresponding CU is split may be transferred to the decoder. For example, the information may be defined to a split flag and may be represented with “split_cu_flag”. The split flag may be included in the entire CU, except for the SCU. For example, when a value of the split flag is ‘1’, a corresponding CU is again split into four CUs, and when a value of the split flag is ‘0’, a corresponding CU is no longer split and a coding process of the corresponding CU may be performed.

In an embodiment of FIG. 3, a split process of the CU is exemplified, but the above-described QT structure may be applied even to a split process of a transform unit (TU), which is a basic unit that performs transform.

The TU may be hierarchically split in a QT structure from a CU to code. For example, the CU may correspond to a root node of a tree of the transform unit (TU).

Because the TU is split in a QT structure, the TU split from the CU may be again split into a smaller subordinate TU. For example, a size of the TU may be determined to any one of 32×32, 16×16, 8×8, and 4×4, but the present invention is not limited thereto, and when the TU is high resolution video, a size of the TU may increase or may be various sizes.

For one TU, information representing whether a corresponding TU is split may be transferred to the decoder. For example, the information may be defined to a split transform flag and may be represented with a “split_transform_flag”.

The split transform flag may be included in entire TUs, except for a TU of a minimum size. For example, when a value of the split transform flag is ‘1’, a corresponding TU is again split into four TUs, and a value of the split transform flag is ‘0’, a corresponding TU is no longer split.

As described above, the CU is a basic unit of coding that performs intra prediction or inter prediction. In order to more effectively code input image, the CU may be split into a prediction unit (PU).

A PU is a basic unit that generates a prediction block, and a prediction block may be differently generated in a PU unit even within one CU. The PU may be differently split according to whether an intra prediction mode is used or an inter prediction mode is used as a coding mode of the CU to which the PU belongs.

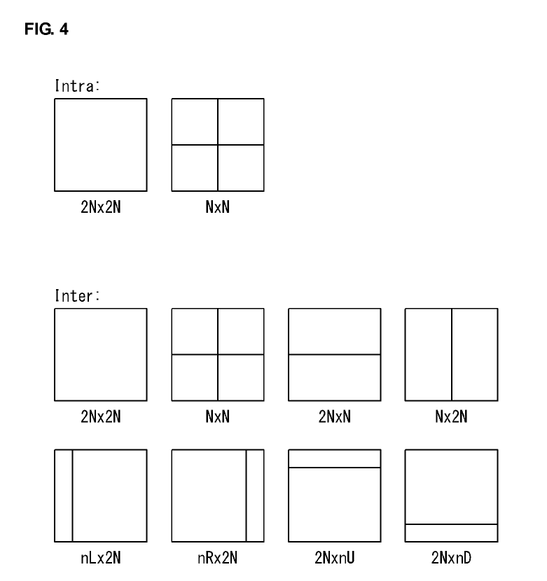

FIG. 4 is an embodiment to which the present invention is applied and is a diagram for illustrating a prediction unit.

A PU is differently partitioned depending on whether an intra-prediction mode or an inter-prediction mode is used as the coding mode of a CU to which the PU belongs.

FIG. 4(a) illustrates a PU in the case where the intra-prediction mode is used as the coding mode of a CU to which the PU belongs, and FIG. 4(b) illustrates a PU in the case where the inter-prediction mode is used as the coding mode of a CU to which the PU belongs.

Referring to FIG. 4(a), assuming the case where the size of one CU is 2N×2N (N=4, 8, 16 or 32), one CU may be partitioned into two types (i.e., 2N×2N and N×N).

In this case, if one CU is partitioned as a PU of the 2N×2N form, this means that only one PU is present within one CU.

In contrast, if one CU is partitioned as a PU of the N×N form, one CU is partitioned into four PUs and a different prediction block for each PU is generated. In this case, the partition of the PU may be performed only if the size of a CB for the luma component of a CU is a minimum size (i.e., if the CU is an SCU).

Referring to FIG. 4(b), assuming that the size of one CU is 2N×2N (N=4, 8, 16 or 32), one CU may be partitioned into eight PU types (i.e., 2N×2N, N×N, 2N×N, N×2N, nL×2N, nR×2N, 2N×nU and 2N×nD).

As in intra-prediction, the PU partition of the N×N form may be performed only if the size of a CB for the luma component of a CU is a minimum size (i.e., if the CU is an SCU).

In inter-prediction, the PU partition of the 2N×N form in which a PU is partitioned in a traverse direction and the PU partition of the N×2N form in which a PU is partitioned in a longitudinal direction are supported.

Furthermore, the PU partition of nL×2N, nR×2N, 2N×nU and 2N×nD forms, that is, asymmetric motion partition (AMP) forms, are supported. In this case, ‘n’ means a ¼ value of 2N. However, the AMP cannot be used if a CU to which a PU belongs is a CU of a minimum size.

In order to efficiently code an input image within one CTU, an optimum partition structure of a coding unit (CU), a prediction unit (PU) and a transform unit (TU) may be determined based on a minimum rate-distortion value through the following execution process. For example, an optimum CU partition process within a 64×64 CTU is described. A rate-distortion cost may be calculated through a partition process from a CU of a 64×64 size to a CU of an 8×8 size, and a detailed process thereof is as follows.

1) A partition structure of an optimum PU and TU which generates a minimum rate-distortion value is determined by performing inter/intra-prediction, transform/quantization and inverse quantization/inverse transform and entropy encoding on a CU of a 64×64 size.

2) The 64×64 CU is partitioned into four CUs of a 32×32 size, and an optimum partition structure of a PU and a TU which generates a minimum rate-distortion value for each of the 32×32 CUs is determined.

3) The 32×32 CU is partitioned into four CUs of a 16×16 size again, and an optimum partition structure of a PU and a TU which generates a minimum rate-distortion value for each of the 16×16 CUs is determined.

4) The 16×16 CU is partitioned into four CUs of an 8×8 size again, and an optimum partition structure of a PU and a TU which generates a minimum rate-distortion value for each of the 8×8 CUs is determined.

5) An optimum partition structure of a CU within a 16×16 block is determined by comparing the rate-distortion value of a 16×16 CU calculated in the process 3) with the sum of the rate-distortion values of the four 8×8 CUs calculated in the process 4). This process is performed on the remaining three 16×16 CUs in the same manner.

6) An optimum partition structure of a CU within a 32×32 block is determined by comparing the rate-distortion value of a 32×32 CU calculated in the process 2) with the sum of the rate-distortion values of the four 16×16 CUs calculated in the process 5). This process is performed on the remaining three 32×32 CUs in the same manner.

7) Finally, an optimum partition structure of a CU within a 64×64 block is determined by comparing the rate-distortion value of the 64×64 CU calculated in the process 1) with the sum of the rate-distortion values of the four 32×32 CUs obtained in the process 6).

In the intra-prediction mode, a prediction mode is selected in a PU unit and prediction and a reconfiguration are performed in an actual TU unit with respect to the selected prediction mode.

The TU means a basic unit by which actual prediction and a reconfiguration are performed. The TU includes a transform block (TB) for a luma component and a TB for two chroma components corresponding to the TB for a luma component.

In the example of FIG. 3, as in the case where one CTU is partitioned as a quadtree structure to generate a CU, a TU is hierarchically partitioned as a quadtree structure from one CU to be coded.

The TU is partitioned as a quadtree structure, and thus a TU partitioned from a CU may be partitioned into smaller lower TUs. In HEVC, the size of the TU may be determined to be any one of 32×32, 16×16, 8×8 and 4×4.

Referring back to FIG. 3, it is assumed that the root node of a quadtree is related to a CU. The quadtree is partitioned until a leaf node is reached, and the leaf node corresponds to a TU.

More specifically, a CU corresponds to a root node and has the smallest depth (i.e., depth=0) value. The CU may not be partitioned depending on the characteristics of an input image. In this case, a CU corresponds to a TU.

The CU may be partitioned in a quadtree form. As a result, lower nodes of a depth 1 (depth=1) are generated. Furthermore, a node (i.e., leaf node) that belongs to the lower nodes having the depth of 1 and that is no longer partitioned corresponds to a TU. For example, in FIG. 3(b), a TU(a), a TU(b) and a TU(j) corresponding to nodes a, b and j, respectively, have been once partitioned from the CU, and have the depth of 1.

At least any one of the nodes having the depth of 1 may be partitioned in a quadtree form again. As a result, lower nodes having a depth 2 (i.e., depth=2) are generated. Furthermore, a node (i.e., leaf node) that belongs to the lower nodes having the depth of 2 and that is no longer partitioned corresponds to a TU. For example, in FIG. 3(b), a TU(c), a TU(h) and a TU(i) corresponding to nodes c, h and i, respectively, have been twice partitioned from the CU, and have the depth of 2.

Furthermore, at least any one of the nodes having the depth of 2 may be partitioned in a quadtree form again. As a result, lower nodes having a depth 3 (i.e., depth=3) are generated. Furthermore, a node (i.e., leaf node) that belongs to the lower nodes having the depth of 3 and that is no longer partitioned corresponds to a CU. For example, in FIG. 3(b), a TU(d), a TU(e), a TU(f) and a TU(g) corresponding to nodes d, e, f and g, respectively, have been partitioned three times from the CU, and have the depth of 3.

A TU having a tree structure has predetermined maximum depth information (or the greatest level information) and may be hierarchically partitioned. Furthermore, each partitioned TU may have depth information. The depth information may include information about the size of the TU because it indicates the partitioned number and/or degree of the TU.

Regarding one TU, information (e.g., a partition TU flag “split_transform_flag”) indicating whether a corresponding TU is partitioned may be transferred to the decoder. The partition information is included in all of TUs other than a TU of a minimum size. For example, if a value of the flag indicating whether a corresponding TU is partitioned is “1”, the corresponding TU is partitioned into four TUs again. If a value of the flag indicating whether a corresponding TU is partitioned is “0”, the corresponding TU is no longer partitioned.

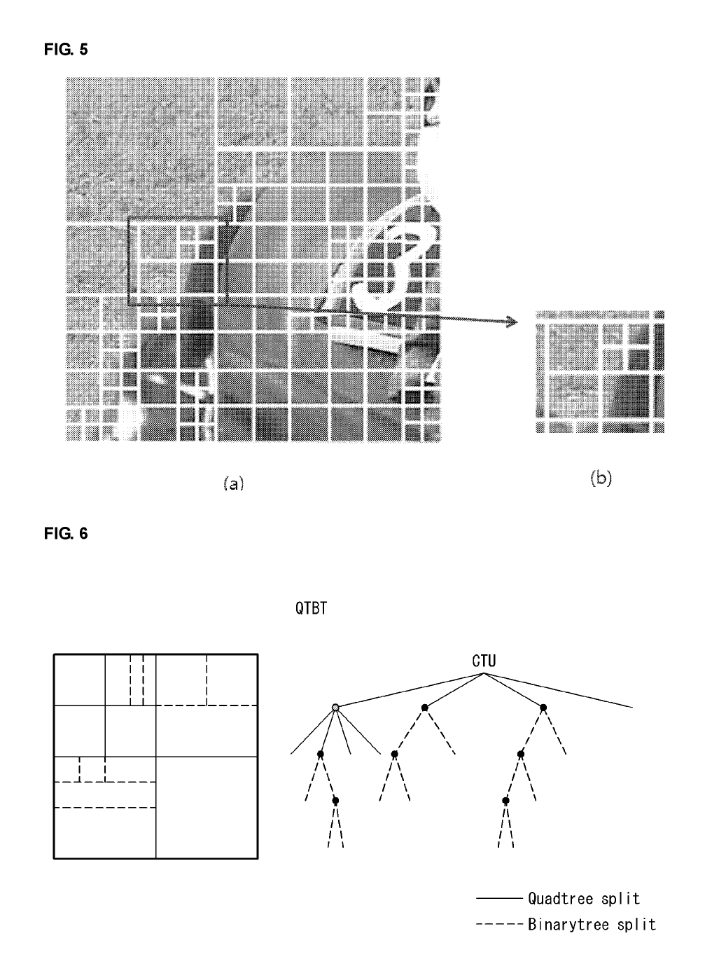

FIG. 5 is an embodiment to which the present invention may be applied and is a diagram for illustrating a quadtree (hereinafter referred to as a “QT”) block division structure and problems thereof.

The present invention can reduce a lot of additional information using information, coded in a luma component, for chroma component coding. Specifically, when a coding unit of a chroma component is defined, the partition of a luma component can be borrowed without any change.

Referring to FIG. 5(a), a coding unit may be basically partitioned into four according to a square quadtree method. The partition chiefly occurs in the boundary portion of an object, and enables high-quality video compression because the accuracy of prediction is increases as the coding unit is subdivided. A degree of partition is indicated as a quadtree depth. A degree of partition is indicated as a depth 0 in a maximum unit size, and means that more partition has been performed as the size of the depth increases.

However, if a partition method enables only 4 partitions, it is difficult to handle shapes of various objects. If 2 equal partitions have been performed in the partition of an upper depth as in FIG. 5(b), bits for partition and additional information, such as prediction information, with respect to one subblock may be less transmitted. However, a bottom-left coding unit (CU) occurs due to a quadtree split. A binarytree split method may also be applied as in FIG. 6 in order to prevent the occurrence of additional information attributable to over split as described above and to enable a more adaptive partition for video.

FIG. 6 is an embodiment to which the present invention is applied and is a diagram for illustrating a quadtree binarytree (hereinafter referred to as a “QTBT”) block division structure.

Quad-Tree Binary-Tree (QTBT)

A QTBT refers to a structure of a coding block in which a quadtree structure and a binarytree structure have been combined. Specifically, in a QTBT block division structure, an image is coded in a CTU unit. A CTU is split in a quadtree form. A leaf node of a quadtree is additionally split in a binarytree form.

Hereinafter, a QTBT structure and a split flag syntax supporting the same are described with reference to FIG. 6.

Referring to FIG. 6, a current block may be split in a QTBT structure. That is, a CTU may be first hierarchically split in a quadtree form. Furthermore, a leaf node of the quadtree that is no longer spit in a quadtree form may be hierarchically split in a binarytree form.

The encoder may signal a split flag in order to determine whether to split a quadtree in a QTBT structure. In this case, the quadtree split may be adjusted (or limited) by a MinQTLumaISlice, MinQTChromaISlice or MinQTNonISlice value. In this case, MinQTLumaISlice indicates a minimum size of a quadtree leaf node of a luma component in an I-slice. MinQTLumaChromaISlice indicates a minimum size of a quadtree leaf node of a chroma component in an I-slice. MinQTNonISlice indicates a minimum size of a quadtree leaf node in a non-I-slice.

In the quadtree structure of a QTBT, a luma component and a chroma component may have independent division structures in an I-slice. For example, in the case of an I-slice in the QTBT structure, the division structures of a luma component and chroma component may be differently determined. In order to support such a division structure, MinQTLumaISlice and MinQTChromaISlice may have different values.

For another example, in a non-I-slice of a QTBT, the division structures of a luma component and chroma component in the quadtree structure may be identically determined. For example, in the case of a non-I-slice, the quadtree split structures of a luma component and chroma component may be adjusted by a MinQTNonISlice value.

In the QTBT structure, a leaf node of the quadtree may be split in a binarytree form. In this case, the binarytree split may be adjusted (or limited) by MaxBTDepth, MaxBTDepthISliceL and MaxBTDepthISliceC. In this case, MaxBTDepth indicates a maximum depth of the binarytree split based on a leaf node of the quadtree in a non-I-slice. MaxBTDepthISliceL indicates a maximum depth of the binarytree split of a luma component in an I-slice. MaxBTDepthISliceC indicates a maximum depth of the binarytree split of a chroma component in the I-slice.

Furthermore, in the I-slice of a QTBT, MaxBTDepthISliceL and MaxBTDepthISliceC may have different values in the I-slice because a luma component and a chroma component may have different structures.

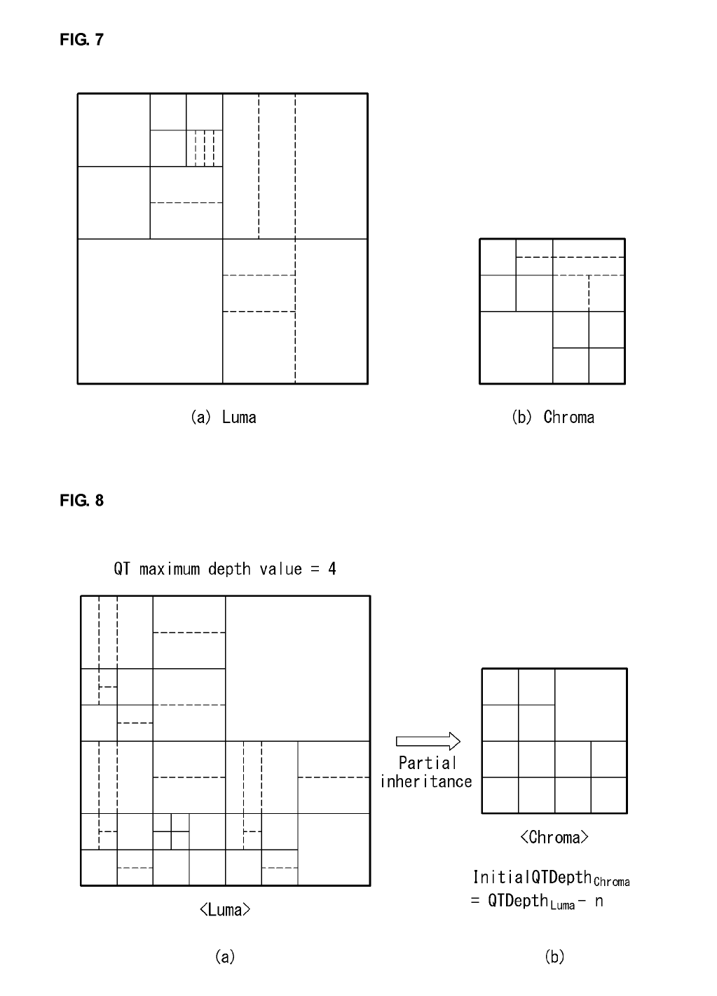

FIG. 7 is an embodiment to which the present invention is applied and is a diagram for illustrating a comparison between the block division structures of a QTBT for a luma component and a chroma component.

Referring to FIG. 7, it is assumed that a current slice is an I-slice. FIG. 7(a) shows the division structure of a QTBT for a luma component, and FIG. 7(b) shows the division structure of a QTBT for a chroma component. A leaf node of a quadtree split in a quadtree structure may be split in a binarytree form. As described above, in the I-slice, the luma component and chroma component may have different division structures.

FIG. 8 is an embodiment to which the present invention is applied and shows that the division structure of a chroma component is determined using some of quadtree split information of a luma component.

In the case of the division structure of a QTBT, the quadtree structure and the binarytree structure may be used together. In this case, the following rule may be applied.

First, MaxBTSize is smaller than or equal to MaxQTSize. In this case, MaxBTSize indicates a maximum size of a binarytree split, and MaxQTSize indicates a maximum size of the quadtree split.

Second, a leaf node of a QT becomes the root of a BT.

Third, once a split into a BT is performed, it cannot be split into a QT again.

Fourth, a BT defines a vertical split and a horizontal split.

Fifth, MaxQTDepth, MaxBTDepth are previously defined. In this case, MaxQTDepth indicates a maximum depth of a quadtree split, and MaxBTDepth indicates a maximum depth of a binarytree split.

Sixth, MaxBTSize, MinQTSize may be different depending on a slice type.

As described above, the QTBT structure may be represented like FIG. 7.

In the YCbCr format, luma and chroma components have similarity because video has been divided into the luma and chroma components, but the chroma component is simpler than the luma component.

Accordingly, the present invention provides a method of improving coding efficiency by preserving the unique characteristics of each component. For example, in the present invention, coding may be performed by defining a unique division structure of a chroma component separately from the division structure of a luma component.

An embodiment of the present invention proposes a method of defining a coding unit of a chroma component using some of division information of a luma component.

A small coding unit compared to a chroma component may be applied to a luma component because the luma component includes a lot of detailed information of video, such as edge information of an object. If a chroma component borrows division information of a luma component without any change, a relatively monotonous coding unit of the chroma component compared to the luma component may be generated as a subdivided structure compared to that expected. In contrast, if a coding unit of a chroma component is defined independently of a luma component, additional information on the division of the chroma component may be increased although the entire throughput of data is small compared to the luma component.

Accordingly, the present embodiment proposes a method using division information of a luma component, but using only some division information of the luma component without using the entire division information. After division information of a luma component is applied, unique division for a chroma component may be additionally applied. In this case, it is assumed that division is performed as a QTBT structure.

Inherit Some of Quadtree Structure of Luma Component

FIG. 8 shows an embodiment in which the quadtree structure of a luma block corresponding to a chroma block is inherited and some of a quadtree depth is used.

Referring to FIG. 8, FIG. 8(a) shows the division structure of a luma block in which a QT maximum depth value is 4. FIG. 8(b) shows the division structure of a chroma block using only some characteristics of the division structure of a luma block.

For example, division information of a chroma block may be derived from a luma block. However, in this case, division information corresponding to all the depths of the luma block is not used, but a specific depth or some division information may be used. This may be formulated like Equation 1.

InitialQTDepth_{Chroma}=QTDepth_{Luma}−n [Equation 1]

In this case, InitialQTDepth_{Chroma} indicates a quadtree depth value of a chroma component, QTDepth_{Luma} indicates a quadtree depth value of a luma block, and n indicates depth inheritance information. In this case, the depth inheritance information may mean a predetermined value used to determine the split depth of the chroma component. For example, the depth inheritance information may be a value empirically determined through various video experiments.

For another example, the depth inheritance information may mean a value indicating split depth information of a luma block or a degree of use of a division structure. That is, the depth inheritance information means information regarding that a chroma block uses split depth information of the luma block to some extent.

For another example, the depth inheritance information may mean a value indicating that a reduction has been performed from the split depth of a luma block to some extent. For example, when depth inheritance information is 1, this may mean that the split depth value of a chroma block is a value reduced by 1 from the split depth value of a luma block.

FIG. 8 shows a case where n=2. Since QTDepth_{Luma} is 4, InitialQTDepth_{Chroma} of a chroma block is 2. Accordingly, the division structure of a chroma block may be represented like FIG. 8(b).

In one embodiment, the depth inheritance information may be defined in at least one level of a video parameter set, a sequence parameter set, a picture parameter set, a slice segment header, or a coding unit header. Alternatively, the depth inheritance information is a preset integer value and may be a value known to the encoder and the decoder.

For another example, the depth inheritance information may be signaled and transmitted or may be activated based on a specific threshold agreed between the encoder and the decoder. As described above, a flag bit for division information can be reduced by adaptively using the division structure of a luma component for a chroma component.

For another example, a configuration may be performed so that upon coding of a chroma component, only a division according to the depth inheritance information is performed and no further division is performed.

For another example, upon coding of a chroma component, a finer division may be performed compared to the division structure of a luma component. In this case, division information of the chroma component may be additionally transmitted. The division information may be quadtree split information, binarytree split information or QTBT split information.

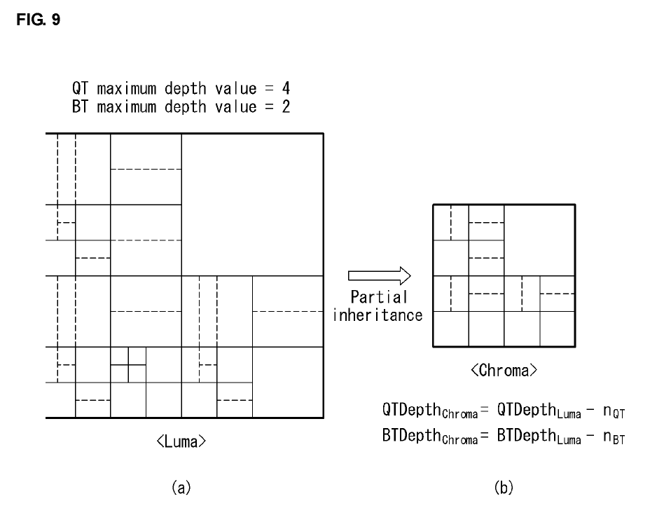

FIG. 9 is an embodiment to which the present invention is applied and shows that the division structure of a chroma component is determined using some of quadtree and binarytree split information of a luma component.

Inherit Some of Quadtree and Binarytree Structure of Luma Component

FIG. 9 shows an embodiment in which the QTBT structure of a luma block corresponding to a chroma block is inherited and some structure of a QTBT depth is used.

Referring to FIG. 9, FIG. 9(a) shows the division structure of a luma block in which a QT maximum depth value is 4 and a BT maximum depth value is 2. FIG. 9(b) shows the division structure of a chroma block using only some properties of the QTBT structure of a luma block.

For example, division information of a chroma block may be derived from a luma block. However, in this case, division information corresponding to all the depths of the luma block is not used, but a specific depth or some division information may be used. First, a method of determining the QT split structure of a chroma block using some of QT division information of a luma block may be formulated like Equation 2.

InitialQTDepth_{Chroma}=QTDepth_{Luma}−n_{QT} [Equation 2]

In this case, InitialQTDepth_{Chroma} indicates a quadtree depth value of a chroma component, QTDepth_{Luma} indicates a quadtree depth value of a luma block, and n_{QT} indicates QT depth inheritance information. In this case, the QT depth inheritance information may mean a predetermined value used to determine a QT split depth of the chroma component. For example, the QT depth inheritance information may be a value empirically determined through various video experiments.

FIG. 9 show a case where n_{QT}=2. Since QTDepth_{Luma} is 4, InitialQTDepth_{Chroma} of a chroma block is 2. Accordingly, the QT split structure of a chroma block may be represented like FIG. 9(b).

Furthermore, if a split is performed from a QT leaf node of a chroma block to a BT, BT split information of a luma block may be used to determine BT split information of the chroma block.

Even in this case, likewise, division information corresponding to all the BT depths of the luma block is not used, but a specific depth or some division information may be used.

A method of determining the BT split structure of a chroma block using BT split information of a luma block may be formulated like Equation 3.

BTDepth_{Chroma}=BTDepth_{Luma}−n_{BT}, where InitialQTDepth_{Chroma}=QTDepth_{Luma}−n_{QT} [Equation 3]

In this case, BTDepth_{Chroma} indicate a binarytree depth value of a chroma block, BTDepth_{Luma} indicates a binarytree depth value of a luma block, and n_{BT} indicates BT depth inheritance information. In this case, the BT depth inheritance information may mean a predetermined value used to determine the BT split depth of a chroma component. For example, the BT depth inheritance information may be a value empirically determined through various video experiments.

FIG. 9 shows a case where a binarytree split depth value (BTDepth_{Luma}) of the luma component is 2, but the chroma component has inherited (or used) only up to a split depth 1. Accordingly, the BT split structure of the chroma block may be represented like FIG. 9(b). In this case, this corresponds to a case where n_{BT}=1.

In one embodiment, the QT depth inheritance information and/or the BT depth inheritance information may be defined in at least one level of a video parameter set, a sequence parameter set, a picture parameter set, a slice segment header, or a coding unit header. Alternatively, the QT depth inheritance information and/or the BT depth inheritance information is a preset integer value and may be a value known to the encoder and the decoder.

For another example, the QT depth inheritance information and/or the BT depth inheritance information may be signaled and transmitted and may be activated based on a specific threshold agreed between the encoder and the decoder. As described above, a flag bit for division information can be reduced by adaptively using the division structure of a luma component for a chroma component.

For another example, a configuration may be performed so that upon coding of a chroma component, only a division according to the QT depth inheritance information and/or the BT depth inheritance information is performed and no further division is performed.

For another example, upon coding of a chroma component, a finer division may be performed compared to the division structure of a luma component. In this case, division information of the chroma component may be additionally transmitted. The division information may be quadtree split information, binarytree split information or QTBT split information.

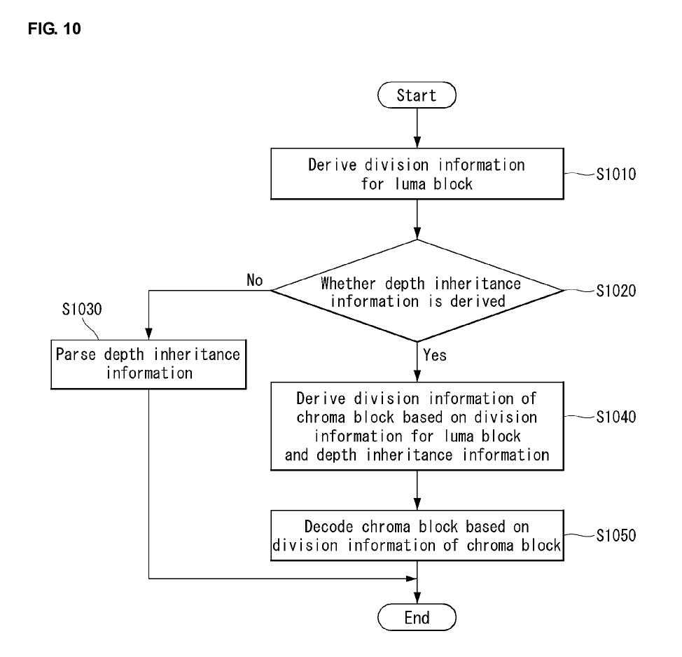

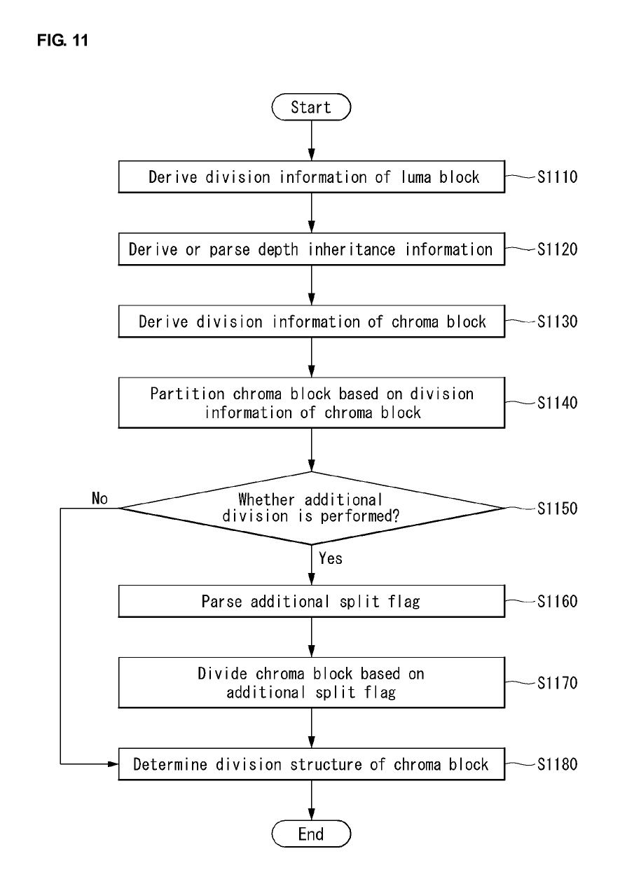

FIG. 10 is an embodiment to which the present invention is applied and is a flowchart showing a process of dividing a chroma block based on division information of a luma block and depth inheritance information.

The present embodiment may be performed in the encoder or the decoder, and is described based on the decoder, for convenience sake.

First, the decoder may receive a video signal and derive division information for a luma block (S1010). In this case, the division information for the luma block may include at least one of size information of the luma block, split depth information, a split flag, or a prediction mode. The split depth information may include at least one of a QT split depth value, a BT split depth value, or a QTBT split depth value. The QTBT split depth value may be represented as one value or may be represented as a set including a QT split depth value and a BT split depth value.

The decoder may identify whether depth inheritance information is derived (S1020). However, this is not an essential step, and the decoder may derive or parse depth inheritance information without a separate confirmation process (S1020, S1030).

In this case, the depth inheritance information may mean a predetermined value used to determine the split depth of a chroma block. For example, the depth inheritance information may be a value empirically determined through various video experiments.

For another example, the depth inheritance information may mean a value indicating split depth information of the luma block or a degree of use of a division structure. That is, the depth inheritance information means information regarding that the chroma block uses the split depth information of the luma block to some extent.

For another example, the depth inheritance information may mean a value indicating that a reduction has been performed from the split depth of the luma block to some extent. For example, when the depth inheritance information is 1, the split depth value of a chroma block may mean a value reduced by 1 from the split depth value of a luma block.

For another example, the depth inheritance information may be defined in at least one level of a video parameter set, a sequence parameter set, a picture parameter set, a slice segment header, or a coding unit header. Alternatively, the depth inheritance information is a preset integer value and may be a value known to the encoder and the decoder.

For another example, the depth inheritance information may be signaled and transmitted or may be activated based on a specific threshold agreed between the encoder and the decoder.

For another example, a configuration may be performed so that when a chroma block is coded, only a division according to the depth inheritance information is performed and no further division is performed.

For another example, when a chroma block is coded, the chroma block may be divided more finely compared to the division structure of a luma component. In this case, additional division information of the chroma block may be separately transmitted. For example, the additional division information may be QT division information, BT split information or QTBT split information.

Meanwhile, the decoder may derive division information of a chroma block based on the division information of the luma block and the depth inheritance information (S1040). For example, in order to derive the division information of the chroma block, at least one of Equation 1 to Equation 3 may be used. In this case, the division information of the chroma block may include at least one of size information of the chroma block, split depth information, a split flag, or a prediction mode. The split depth information may include at least one of a QT split depth value, a BT split depth value, or a QTBT split depth value. The QTBT split depth value may be represented as one value or may be represented as a set, including a QT split depth value and a BT split depth value.

The decoder may decode a chroma block based on the division information of the chroma block (S1050).

FIG. 11 is an embodiment to which the present invention is applied and is a flowchart showing a process of determining the division structure of a chroma block.

The present embodiment may be performed in the encoder or the decoder, and is described based on the decoder, for convenience sake.

First, the decoder may derive division information of a luma block (S1110). In this case, the embodiments described in this specification may be applied to the division information of the luma block, and the division information of the luma block is a redundant description and thus omitted.

The decoder may derive or parse depth inheritance information (S1120). In this case, the embodiments described in this specification may be applied to the depth inheritance information, and the depth inheritance information is a redundant description and thus omitted.

The decoder may derive division information of a chroma block based on the division information of the luma block and the depth inheritance information (S1130). In this case, the embodiments described in this specification may be applied to the division information of the chroma block, and the division information of the chroma block is a redundant description and thus omitted.

The decoder may partition the chroma block based on the division information of the chroma block (S1140).

In step S1140, the decoder may confirm whether a division is additionally performed on the partitioned chroma block (S1150). However, this is not an essential step, and the decoder may derive or parse additional division information without a separate confirmation process (S1160). In this case, the additional division information may include a split flag indicating whether to perform a division. For example, the split flag may include at least one of a QT split flag, a BT split flag, or a QTBT split flag.

The decoder may divide the chroma block based on the additional division information (S1170).

Through the process, the decoder may determine the division structure of the chroma block (S1180).

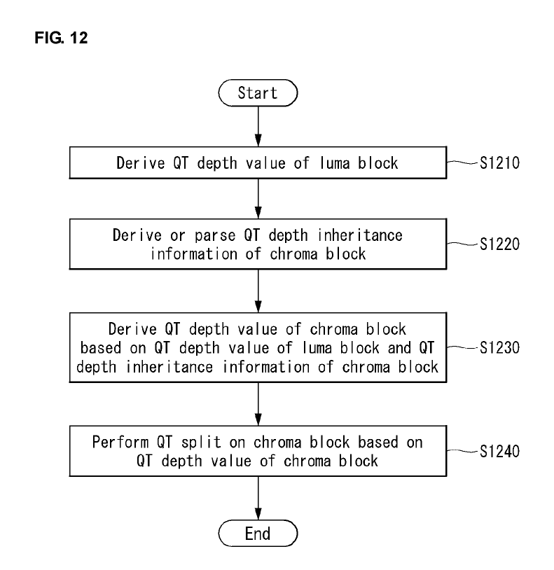

FIG. 12 is an embodiment to which the present invention is applied and is a flowchart showing a process of performing a QT split on a chroma block based on the QT split depth value and QT depth inheritance information of a luma block.

The present embodiment may be performed in the encoder or the decoder, and is described based on the decoder, for convenience sake. Likewise, the embodiments described in this specification may also be applied in the present embodiment, and a redundant description thereof is omitted.

First, the decoder may derive a QT depth value of a luma block (S1210).

The decoder may derive or parse QT depth inheritance information of a chroma block (S1220). In this case, the QT depth inheritance information may mean a predetermined value used to determine the QT split depth of a chroma component.

The decoder may derive the QT depth value of the chroma block based on the QT depth value of the luma block and the QT depth inheritance information of the chroma block (S1230).

The decoder may perform a QT split on the chroma block based on the QT depth value of the chroma block (S1240).

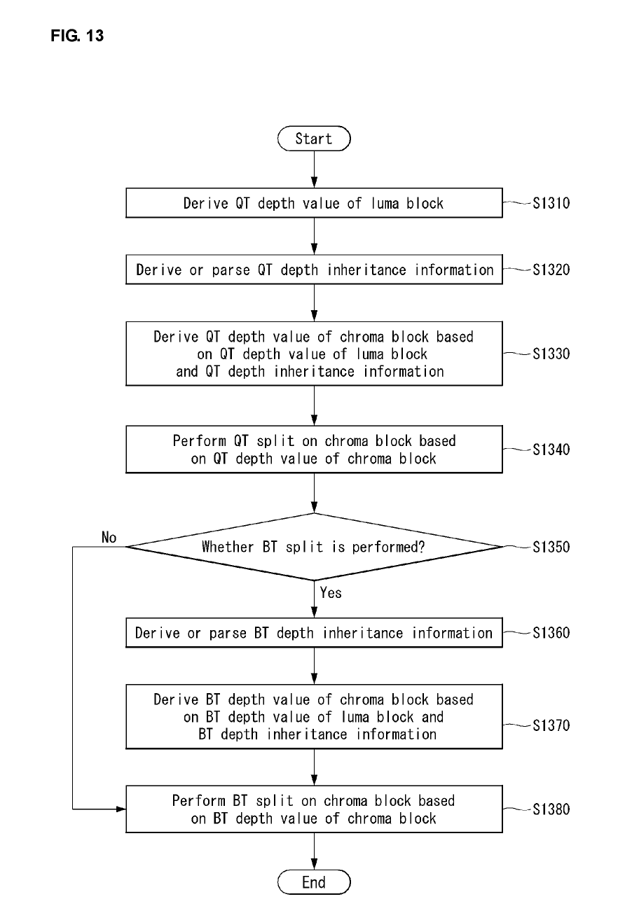

FIG. 13 is an embodiment to which the present invention is applied and is a flowchart showing a process of performing a QT/BT split on a chroma block based on the QT/BT split depth value and QT/BT depth inheritance information of a luma block.

The present embodiment may be performed in the encoder or the decoder, and is described based on the decoder, for convenience sake. Likewise, the embodiments described in this specification may also be applied in the present embodiment, and a redundant description thereof is omitted.

First, the decoder may derive a QT depth value of a luma block (S1310).

The decoder may derive or parse QT depth inheritance information of a chroma block (S1320). In this case, the QT depth inheritance information may mean a predetermined value used to determine the QT split depth of the chroma component.

The decoder may derive a QT depth value of the chroma block based on the QT depth value of the luma block and the QT depth inheritance information of the chroma block (S1330). For example, Equation 2 may be used.

The decoder may perform a QT split on the chroma block based on the QT depth value of the chroma block (S1340).

The decoder may confirm whether the BT split is additionally performed (S1350). However, this is not an essential step, and the decoder may derive or parse BT depth inheritance information without a separate confirmation process (S1360). In this case, the BT depth inheritance information may mean a predetermined value used to determine the BT split depth of a chroma component.

The decoder may derive a BT depth value of the chroma block based on the BT depth value of the luma block and the BT depth inheritance information of the chroma block (S1370). For example, Equation 3 may be used.

The decoder may perform a BT split on the chroma block based on the BT depth value of the chroma block (S1380).

As described above, the embodiments described in the present invention may be implemented and performed on a processor, a microprocessor, a controller or a chip. For example, the function units shown in FIGS. 1 and 2 may be implemented and performed on a computer, a processor, a microprocessor, a controller or a chip.

As described above, the decoder and the encoder to which the present invention is applied may be included in a multimedia broadcasting transmission/reception apparatus, a mobile communication terminal, a home cinema video apparatus, a digital cinema video apparatus, a surveillance camera, a video chatting apparatus, a real-time communication apparatus, such as video communication, a mobile streaming apparatus, a storage medium, a camcorder, a video on demand (VoD) service providing apparatus, an Internet streaming service providing apparatus, a three-dimensional (3D) video apparatus, a teleconference video apparatus, and a medical video apparatus and may be used to code video signals and data signals.

Furthermore, the processing method to which the present invention is applied may be produced in the form of a program that is to be executed by a computer and may be stored in a computer-readable recording medium. Multimedia data having a data structure according to the present invention may also be stored in computer-readable recording media. The computer-readable recording media include all types of storage devices in which data readable by a computer system is stored. The computer-readable recording media may include a BD, a USB, ROM, RAM, CD-ROM, a magnetic tape, a floppy disk, and an optical data storage device, for example. Furthermore, the computer-readable recording media includes media implemented in the form of carrier waves, e.g., transmission through the Internet. Furthermore, a bit stream generated by the encoding method may be stored in a computer-readable recording medium or may be transmitted over wired/wireless communication networks.

### INDUSTRIAL APPLICABILITY

The exemplary embodiments of the present invention have been disclosed for illustrative purposes, and those skilled in the art may improve, change, replace, or add various other embodiments within the technical spirit and scope of the present invention disclosed in the attached claims.

1. A method of decoding a chroma block of a video signal, comprising:
deriving division information of a luma block, wherein the division information of the luma block includes split depth information of the luma block;
parsing depth inheritance information for the chroma block from the video signal, wherein the depth inheritance information indicates a utilization degree of the split depth information of the luma block;
deriving division information of the chroma block based on at least one of the split depth information of the luma block or the depth inheritance information, wherein the division information of the chroma block includes split depth information of the chroma block; and
decoding the chroma block based on the division information of the chroma block.

2. The method of claim 1,
wherein the depth inheritance information indicates a predetermined value used to determine the split depth of the chroma block.

3. The method of claim 1,
wherein the split depth information of the chroma block is derived as a value obtained by subtracting the depth inheritance information from the split depth information of the luma block.

4. The method of claim 1,
wherein the split depth information of the chroma block, the split depth information of the luma block and the depth inheritance information correspond to any one of a quad-tree (QT), a binary-tree (BT) or a quad-tree binary-tree (QTBT).

5. The method of claim 1, further comprising:
parsing an additional split flag from the video signal; and
dividing a split chroma block based on the additional split flag, wherein the split chroma block indicates a chroma block divided based on the split depth information of the chroma block,
wherein the additional split flag indicates whether division is additionally performed on the divided chroma block.

6. The method of claim 5,
wherein the additional split flag comprises at least one of a quad-tree (QT) split flag, a binary-tree (BT) split flag, or a quad-tree binary-tree (QTBT) split flag.

7. The method of claim 1,
wherein the depth inheritance information is defined in at least one level of a video parameter set, a sequence parameter set, a picture parameter set, a slice segment header, or a coding unit header.

8. An apparatus for decoding a chroma block of a video signal, comprising:
a parsing unit configured to parse depth inheritance information for the chroma block from the video signal, wherein the depth inheritance information indicates a utilization degree of split depth information of a luma block;
a block split determination unit configured to derive the split depth information of the luma block and derive split depth information of the chroma block based on at least one of the split depth information of the luma block or the depth inheritance information; and
a decoding unit configured to decode the chroma block based on division information of the chroma block.

9. The apparatus of claim 8,
wherein the depth inheritance information indicates a predetermined value used to determine the split depth of the chroma block.

10. The apparatus of claim 8,
wherein the split depth information of the chroma block is derived as a value obtained by subtracting the depth inheritance information from the split depth information of the luma block.

11. The apparatus of claim 8,
wherein the split depth information of the chroma block, the split depth information of the luma block and the depth inheritance information correspond to any one of a quad-tree (QT), a binary-tree (BT) or a quad-tree binary-tree (QTBT).

12. The apparatus of claim 8, further comprising:
a parsing unit configured to parse an additional split flag from the video signal; and
a block split determination unit configured to divide a divided chroma block based on the additional split flag, wherein the divided chroma block indicates a chroma block divided based on the split depth information of the chroma block,
wherein the additional split flag indicates whether division is additionally performed on the divided chroma block.

13. The apparatus of claim 12,
wherein the additional split flag comprises at least one of a quad-tree (QT) split flag, a binary-tree (BT) split flag, or a quad-tree binary-tree (QTBT) split flag.

14. The apparatus of claim 8,
wherein the depth inheritance information is defined in at least one level of a video parameter set, a sequence parameter set, a picture parameter set, a slice segment header, or a coding unit header.
